(19) United States
(12) Patent Application Publication
(10) Pub. No.: US 2009/0323989 A1
(43) Pub. Date: Dec. 31, 2009

(54) System and method for calibrating an audiometer signal

(76) Inventors: Robert CAPPER, Roanoke, VA (US); Duncan MacAllister, Roanoke, VA (US); Ronald Webster, Roanoke, VA (US)

Correspondence Address: D. Joseph English, Suite 1000, 505 9th Street, N.W., Washington, DC, 20004, US

(21) Appl. No.: 12/213,185

(22) Filed: Jun. 16, 2008

(51) Int. Cl. H04R 25/00

(52) U.S. Cl. 381/151

(57) ABSTRACT

A system and method for providing a translated or calibrated signal to a bone conduction transducer. The frequency of an audiometer output signal is detected and attenuation and amplification calibration values may be determined from a lookup table as a function of this frequency. Characteristics of the output signal may then be varied as a function of the calibration values to provide a translated or calibrated signal. This signal may then be provided to an exemplary bone conduction transducer such as a piezoelectric, electrostrictive or other electroactive bone conduction transducer.

### BACKGROUND

Generally, the hearing of an individual may be tested such that an acoustic signal and, thus, an acoustic wave are presented via suitable electroacoustic means to the individual monaurally or binaurally, and the individual reacts subjectively to corresponding questions that are matched to the respective purpose of the psychoacoustic examination. These electroacoustic means are generally termed as audiometers. Conventionally, a test signal may be produced either electronically (analog or digital signal generators) or provided from a suitable audio medium (magnetic tape, compact disc, etc.). These test signals may then be presented to the individual acoustically via loudspeakers under free field conditions or via specially calibrated measurement headphones.

The perception of sound is achieved in human beings generally through the ear. Sound is transmitted to the ear through vibrations in the air known as air conduction. However, sound may also be transmitted through the human bone structure (the skull). This form of sound transmission is known as bone conduction.

In normal hearing, sound passes along an individual's ear canals to the eardrum causing the surface of the eardrum to vibrate. These vibrations are received by the most external of the middle ear bones, the malleus, which has a process, the manubrium, contacting the eardrum. Movement of the eardrum causes the manubrium and the rest of the malleus to vibrate. In turn, these vibrations pass acoustic energy across the oval window and innervate the movement of the cochlear fluids. Movement in this fluid bends the hair cells along the length of the cochlea, generating signals in the auditory nerve. These signals are then transferred to the brain, thus the interpretation of sound.

The ability to hear and the sensitivity at which one is able to hear is generally diminished by two types of ear pathologies: 1) conductive hearing loss and 2) sensory-neural hearing loss. Conductive hearing loss may be traced to either a pathological condition of the middle ear or the middle-ear cavity, or impairment (i.e., blockage) of canal or the outer ear. Sensory-neural hearing loss is generally a result of a pathological condition of the inner ear.

Assessment of hearing loss is normally conducted by testing for minimum detectable sound amplitude levels. There are two forms of tests used for the basic evaluation of auditory function. The first test, air-conduction testing, involves presenting precisely calibrated sounds to the ears, usually by routing the signals through headphones to the external ear canal. The second test, bone-conduction testing, sends precisely calibrated signals through the bones of the skull to the inner ear system. Stimulation is received at the skull by placing a transducer either on the mastoid region behind the ear to be tested or through transducer placement on the forehead.

Hearing by bone conduction as a phenomenon, i.e., hearing sensitivity to vibrations induced directly or via skin or teeth to the skull bone, has been known since the 19th century. Interest in bone conduction was initially based upon its usefulness as a diagnostic tool. In particular, bone conduction is generally utilized in hearing threshold testing to determine the sensory-neural hearing loss or, indirectly, to determine the degree of conduction hearing loss by noting the difference between the air and the bone thresholds.

Differences between hearing loss profiles for air and bone conduction may indicate a probable locus for a hearing problem. For example, if air-conduction scores are poorer than bone-conduction scores, the indication presents that a flaw is present in the mechanisms that carry sound from the eardrum to the inner ear. Remediation of this type of problem might involve surgical repair of damaged conductive elements. If bone-conduction and air-conduction scores show similar levels of hearing loss, then it is likely that there is a deficiency in sensory-neural functions.

In the hearing threshold testing field, one of the more commonly used bone conduction transducers is the Radio Ear B-71 transducer, a variable reluctance electromagnetic transducer. FIGS. 1a and 1b are illustrations of an exemplary B-71 transducer 100. Variable reluctance type transducers function according to the horseshoe magnet principle where there is an air gap 8 between an armature 10 and a yoke 12. By superimposing a magnetic flux generated by a coil 14, the force in the air gap 8, between the yoke 12 and the armature 10, will vary accordingly. This force may be used to generate vibrations in a mass 15 situated in the transducer 100. Exemplary transducers include a housing 16 with a circular attachment surface 18 applied toward an individual's head. Electrical inputs may be provided via an electrical connector 20. With a headband 22, the transducer 100 may be pressed against the mastoid area behind an individual's ear.

Conventional variable reluctance type transducers and the associated driving or controlling electronic equipment suffer from several problems. As a result of the design and number of components in this type of bone conduction transducer, constant recalibration may be required due to accidental dropping or simply loss of calibration during normal use. Another problem is a poor frequency response for this type of transducer. For example, the poor frequency response of this conventional technology has forced the current hearing threshold testing field standards and limitations in the ANSI S3.43 (1992) standards for bone conduction transducers.

Another problem of conventional bone conduction transducers is the necessity of being driven or controlled by an audiometer and the associated electronic circuits that generally requires calibration to ensure the bone conduction transducer provides the expected output performance. In a typical calibration process, the audiometer output voltage is adjusted for each frequency step required, e.g., 250 Hz, 500 Hz, 750 Hz, 1000 Hz, 1500 Hz, 2000 Hz, 3000 Hz and 4000 Hz, using an artificial mastoid. For each of these specific frequencies, the audiometer may be tuned so that the bone conduction transducer will provide the output force value required by the ANSI standard. In the prior art, this process is time consuming and limiting if the bone conduction transducer is expected to be utilized in a different frequency point from those previously calibrated. Yet another issue with conventional bone conduction transducers is the use of a magnetic transducer, which creates electromagnetic interference (“EMI”). This EMI interferes with surrounding medical and/or radio frequency devices.

Piezoelectric bone conduction transducers have gained popularity in the industry. Generally, piezoelectric bone conduction transducers provide a greater frequency response, e.g., 100 Hz to 8000 Hz, than conventional electromagnetic transducers and eliminate the possibility of EMI interference with surrounding medical and/or radio frequency devices. Piezoelectric bone conduction transducers utilize piezoelectric or electrostrictive (collectively, “electroactive”) materials to develop an electric field when placed under stress or strain. The electric field developed by an electroactive material is a function of the applied force and displacement causing the mechanical stress or strain. Conversely, electroactive devices undergo dimensional changes in an applied electric field. The dimensional change (i.e., expansion or contraction) of an electroactive element is a function of the applied electric field. Electroactive devices are commonly used as drivers, or “actuators” due to their propensity to deform under such electric fields. These actuators may be placed in a housing and energized to generate mechanical vibrations. The respective transducer shape is adapted to be positioned against the skin over the skull of an individual, preferably over the mastoid area of the temporal bone of the skull behind the ear.

There is, however, a need in the art to improve or provide a translation of output signals of an audiometer that may have been originally calibrated at one or more specific test frequencies for use with conventional electromagnetic transducers, to the correct voltage levels required to create equivalent sound pressure output levels in a piezoelectric transducer at one or more specific test frequencies. There is also a need in the art to provide an appropriate driving signal for conventional electromagnetic transducers such as those depicted in FIG. 1 as well as piezoelectric and electrostrictive transducers described in U.S. Pat. No. 6,346,764, filed Dec. 15, 2000, U.S. Pat. No. 5,471,721, filed Feb. 23, 1993, U.S. Pat. No. 5,632,841, filed Apr. 4, 1995, and U.S. patent application Ser. No. 11/482,346, filed Jul. 7, 2006, the entirety of each are incorporated herein by reference.

Accordingly, there is a need for an system and method that would overcome the deficiencies of the prior art. Therefore, an embodiment of the present subject matter provides a method for providing a calibrated signal to a bone conduction transducer. An output signal from an audiometer may be detected and a frequency thereof determined. The method may also comprise determining a calibration value from a lookup table as a function of the frequency and varying one or more characteristics of the output signal as a function of the calibration value.

Another embodiment of the present subject matter may provide a method for controlling a bone conduction transducer. The method may comprise providing a first signal as a function of a voltage condition of an output signal from an audiometer. A first value from the first signal may be determined and a second value determined as a function of this first value. One or more characteristics of the output signal may be varied as a function of the second value thereby providing a second signal. An exemplary bone conduction transducer may then be driven as a function of the second signal.

A further embodiment of the present subject matter may provide a method for translating an audiometer signal. The method may comprise detecting a voltage condition of an output signal from an audiometer and outputting a first signal as a function of the voltage condition. A first value of the first signal may be determined, and a second value determined as a function of the first value. The method may further comprise varying one or more characteristics of the output signal as a function of the second value.

Yet another embodiment of the present subject matter may provide a system for providing a calibrated signal to a bone conduction transducer. The system may comprise a voltage detector configured to detect a voltage condition of an output signal from an audiometer and to provide an edge signal. The system may also include circuitry for determining a calibration value as a function of the edge signal, where the circuitry includes a lookup table adaptable to provide the calibration value as a function of a frequency of the output signal. Further, the system may include circuitry for adjusting one or more characteristics of the output signal as a function of the calibration value. These adjusted signals may then be provided to a bone conduction transducer.

A further embodiment of the present subject matter may provide a method for controlling an electroactive bone conduction transducer. The method may comprise detecting an output signal from an audiometer originally calibrated at one or more frequencies for use with an electromagnetic transducer and determining one or more calibration values from a lookup table as a function of the output signal. One or more characteristics of the output signal may then be varied as a function of the one or more calibration values to thereby control the electroactive bone conductive transducer.

Another embodiment of the present subject matter provide a method comprising detecting a tone outputted from an audiometer and determining the frequency of the tone. A calibration value may be determined as a function of the frequency of the tone, and the tone may be attenuated or amplified as a function of the calibration value. The attenuated or amplified tone may then be provided to a bone conduction transducer.

These embodiments and many other objects and advantages thereof will be readily apparent to one skilled in the art to which the invention pertains from a perusal of the claims, the appended drawings, and the following detailed description of the embodiments.

### BRIEF DESCRIPTION OF THE DRAWINGS

FIG. 1a is a plan view of a prior art electromagnetic technology based bone conduction device.

FIG. 1b is a cross sectional view of a prior art electromagnetic technology based bone conduction device.

FIG. 2 is a block diagram of a system according to one embodiment of the present subject matter.

FIG. 3 is a block diagram of a method according to one embodiment of the present subject matter.

FIG. 4 is a block diagram of another method according to one embodiment of the present subject matter.

FIG. 5 is a block diagram of an additional method according to one embodiment of the present subject matter.

FIG. 6 is a block diagram of an another method according to one embodiment of the present subject matter.

### DETAILED DESCRIPTION

With reference to the figures where like elements have been given like numerical designations to facilitate an understanding of the present subject matter, the various embodiments of an system and method for calibrating an audiometer signal are herein described.

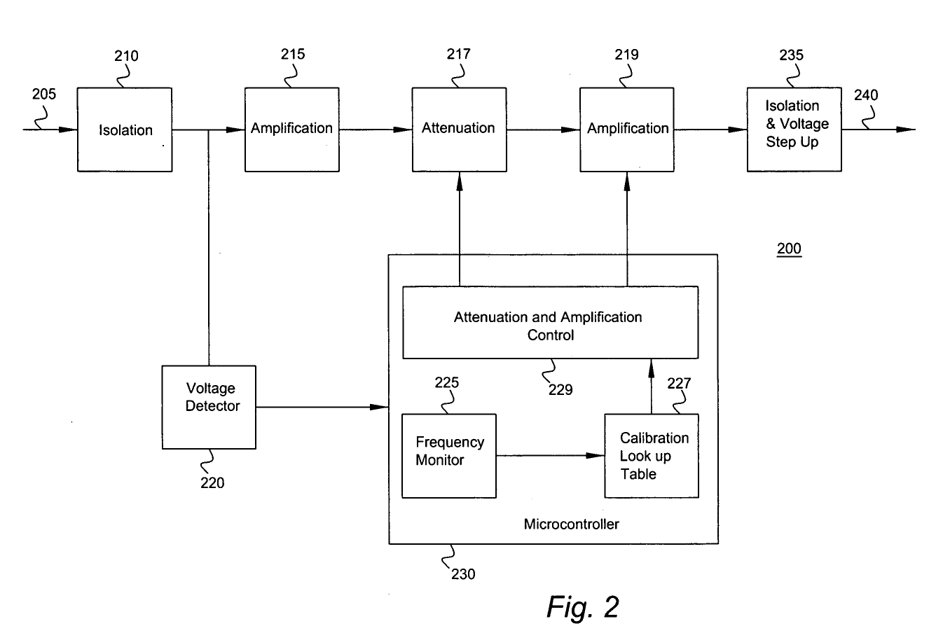

FIG. 2 is a block diagram of a system according to one embodiment of the present subject matter. With reference to FIG. 2, an exemplary system may include a circuit 200 to provide a translation of output signals of an audiometer that may have been originally calibrated at one or more specific test frequencies for use with conventional electromagnetic transducers, to the correct voltage levels required to create equivalent sound pressure output levels in a piezoelectric or electrostrictive (“electroactive”) transducer at one or more specific test frequencies. Exemplary frequencies may range from 100 Hz to 8000 Hz. The circuit 200 may receive an input signal 205 from an audiometer (not shown) or other test instrument. The input signal 205 may be isolated or conditioned by an exemplary isolation circuit 210 such as, but not limited to, a coupling transformer. The output signal of the isolation circuit 210 may be provided to an amplification circuit 215 and a voltage detector 220. The amplification circuit 215 may be a fixed amplifier or any other known amplifier commonly used in the industry. An exemplary voltage detector 220 may be, but is not limited to, a zero crossing detector. The voltage detector 220 may be configured to detect a voltage condition of the output signal of the isolation circuit 210 and provide an edge or comparable signal to a microcontroller or processor 230. An exemplary voltage condition may be, but is not limited to, a zero-crossing voltage condition.

The microcontroller 230 may include a frequency monitor 225, a calibration look-up table 227, and an attenuation and amplification control circuit 229. The frequency monitor 225 may accept the output signal of the voltage detector 220. The frequency monitor 225 may also include a frequency monitoring software algorithm that continuously or periodically determines the frequency of the input signal 205. The output of the frequency monitor 225 may index the calibration look-up table 227. Extracted calibration values may then be provided to an exemplary attenuation and amplification control algorithm or circuit 229. In one embodiment, exemplary calibration values may include one or more attenuation parameters and/or amplification parameters. In another embodiment, an exemplary look-up table may translate response characteristics from an electromagnetic device to an electroactive device. In yet another embodiment, the look-up table may be based upon standard electromagnetic transducer characteristics and characteristics of an electroactive transducer, such as a piezoelectric transducer.

The following Table 1 shows a non-exclusive and exemplary specification for one embodiment of a calibration look-up table 227 and such an example should not limit the scope of the claims appended herewith.

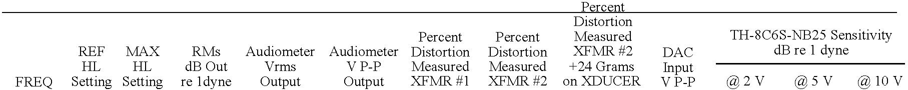

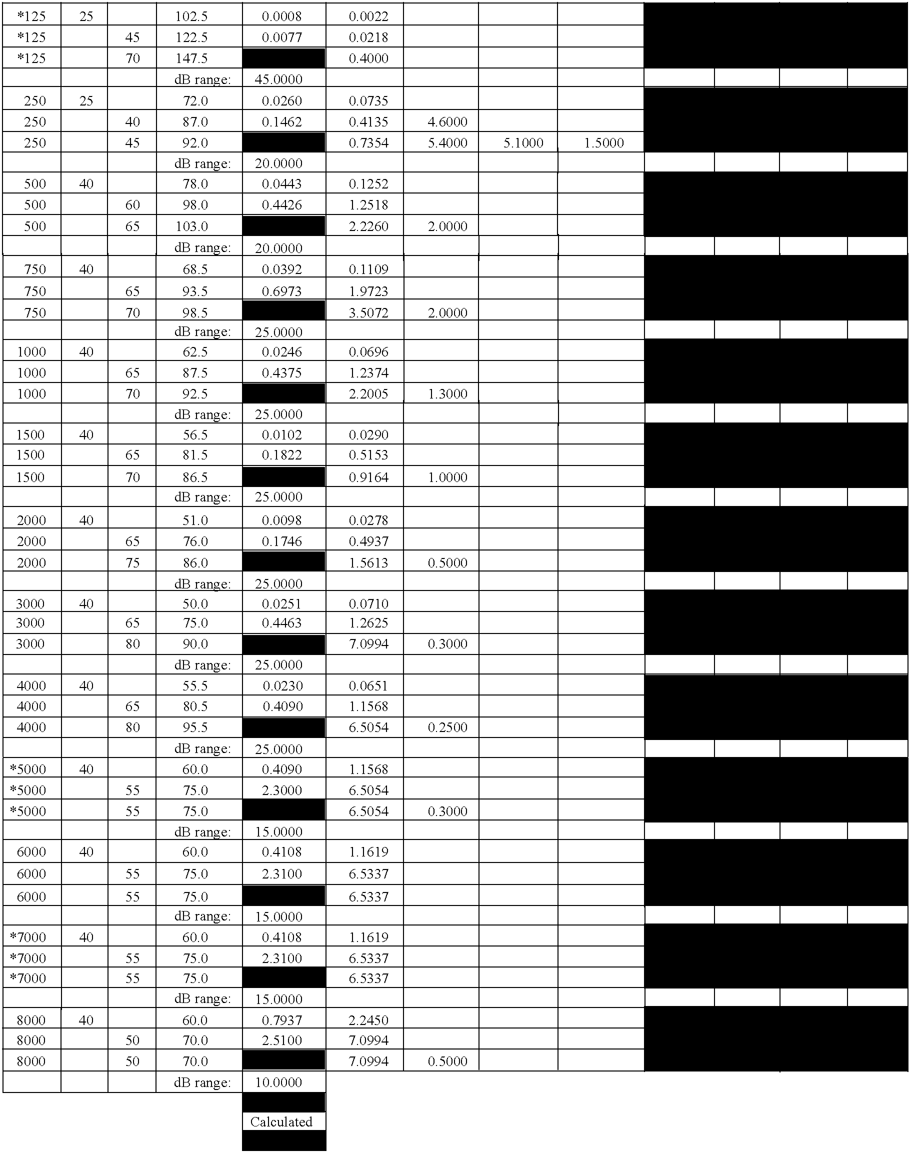

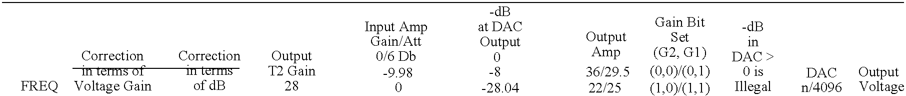

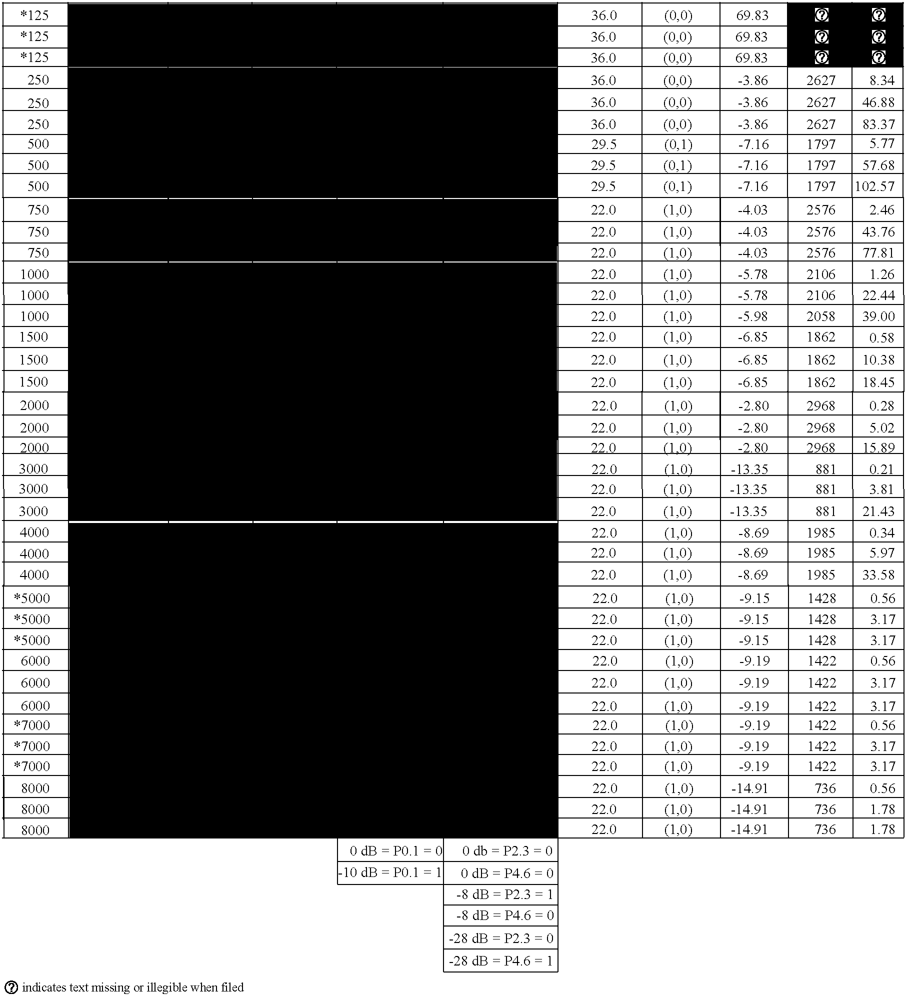

The amplifier 215 may amplify the output of the isolation circuit 210 and provide a stable amplified signal to exemplary attenuation circuitry 217 such as, but not limited to, a variable attenuator. The output of the attenuation circuitry 217 may then be provided to exemplary amplification circuitry 219, such as, but not limited to, a variable amplifier. Of course, the attenuation and amplification circuitry may be combined in a single circuit and such an example should not limit the scope of the claims appended herewith. The attenuation and amplification control algorithm or circuit 229 may provide signals to the attenuation and amplification circuitry 217, 219 to manipulate the output signals therefrom to thereby control how much gain to apply to create an expected output for an electroactive device. Such manipulation may generally result in an appropriate frequency specific output signal 240. In another embodiment, an isolation circuit and/or voltage transformer 235 may be employed to assist in conditioning and providing a correct output signal 240. The output signal 240 may be provided to a bone conduction transducer (not shown) such as, but not limited to, an electromagnetic bone conduction transducer or oscillator, a piezoelectric, electrostrictive, or other electroactive bone conduction transducer. Aspects of circuits according to embodiments of the present subject matter may also boost voltage and provide additional power to electroactive bone conduction transducers.

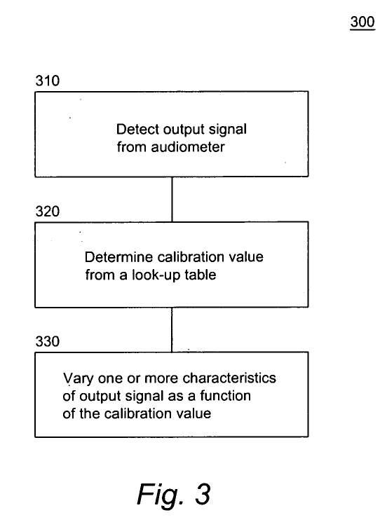

FIG. 3 is a block diagram of a method according to one embodiment of the present subject matter. With reference to FIG. 3, a method for providing a calibrated signal to a bone conduction transducer 300 is provided. The method may include detecting an output signal from an audiometer by determining a frequency of the output signal at step 310. The frequency may be determined as a function of a zero-crossing voltage condition of the output signal and may approximately be in the range of 100 Hz to 8000 Hz. A calibration value may then be determined from a lookup table as a function of the frequency at step 320. One or more characteristics of the output signal may be varied as a function of the calibration value at step 330 to provide a calibrated signal. In one embodiment, an exemplary bone conduction transducer may be, but is not limited to, a piezoelectric, electrostrictive, or other electroactive bone conduction stimulator or transducer.

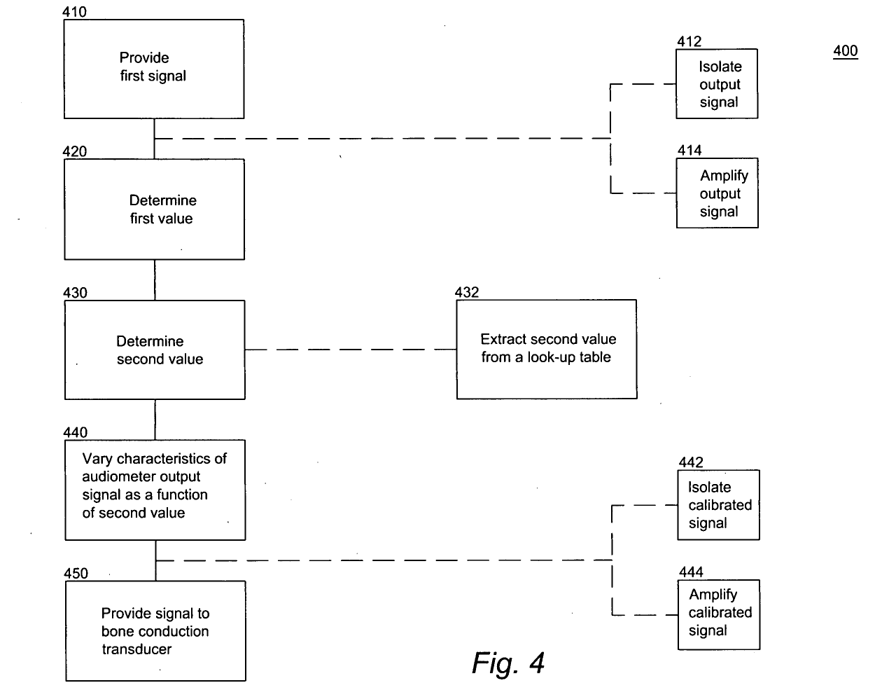

FIG. 4 is a block diagram of another method according to one embodiment of the present subject matter. With reference to FIG. 4, a method for controlling a bone conduction transducer 400 is provided. At step 410, a first signal, such as an edge signal, may be provided as a function of a voltage condition of an output signal from an audiometer. In another embodiment, the output signal may be isolated or conditioned at step 412 and may be amplified at step 414. An exemplary voltage condition may be, but is not limited to, a zero-crossing or comparable voltage condition. A first value of the first signal may be determined at step 420, and at step 430, a second value may be determined as a function of the first value. The first value may be a frequency value where the values may be in the range of 100 Hz to 8000 Hz. An exemplary second value may be a calibration value. The calibration value may be provided from a look-up table comprising a historical index of amplification and attenuation values obtained over a predetermined time. In another embodiment of the present subject matter, the determination of a second value may comprise extracting the second value from the lookup table as a function of the first value at step 432.

One or more characteristics of the output signal may be varied as a function of the second value to thereby provide a calibrated signal at step 440. In one embodiment, one characteristic may be an attenuation characteristic and another characteristic may be an amplitude characteristic. In another embodiment of the present subject matter, the calibrated signal may be isolated or conditioned at step 442 and may be amplified at step 444. As a function of this calibrated signal, a bone conduction transducer may thus be driven or controlled at step 450. An exemplary bone conduction transducer may be, but is not limited to, a piezoelectric, electrostrictive, or other electroactive bone conduction transducer.

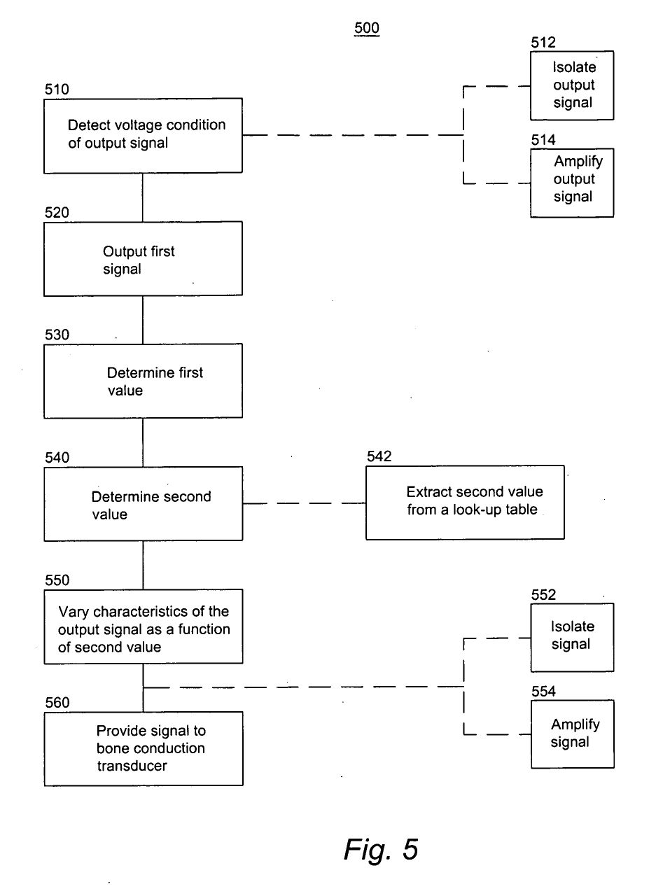

FIG. 5 is a block diagram of an additional method according to one embodiment of the present subject matter. With reference to FIG. 5, a method for translating an audiometer signal 500 is provided. The method may include detecting a voltage condition of an output signal from an audiometer at step 510 and outputting a first signal, such as an edge or comparable signal, as a function of the voltage condition at step 520. An exemplary voltage condition may be, but is not limited to, a zero-crossing or comparable voltage condition. In another embodiment, the output signal may be isolated or conditioned at step 512 and may be amplified at step 514. A first value of the first signal may be determined at step 530, and at step 540, a second value determined as a function of the first value. The first value may be a frequency value in the range of approximately 100 Hz to 8000 Hz. An exemplary second value may be a calibration value. The calibration value may be provided from a look-up table comprising a historical index of amplification and attenuation values obtained over a predetermined time. In another embodiment of the present subject matter, the determination of a second value may comprise extracting the second value from the lookup table as a function of the first value at step 542.

One or more characteristics of the output signal may then be varied as a function of the second value at step 550. This output signal may also be isolated or conditioned at step 552 and may be amplified at step 554. In an additional embodiment of the present subject matter, the method may further comprise driving or controlling a bone conduction transducer as a function of the second signal at step 560. An exemplary bone conduction transducer may be, but is not limited to, a piezoelectric, electrostrictive, or other electroactive bone conduction transducer.

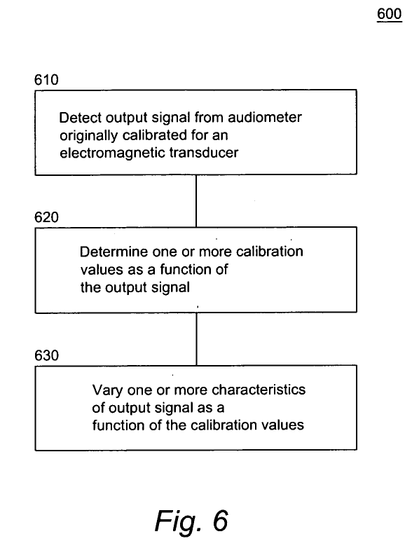

FIG. 6 is a block diagram of another method according to one embodiment of the present subject matter. With reference to FIG. 6, a method for controlling an electroactive bone conduction transducer 600 is provided. The method may comprise detecting an output signal such as a tone from an audiometer that was calibrated at one or more frequencies for use with an electromagnetic transducer at step 610. The frequencies may generally be in the range of 100 Hz to 8000 Hz. At step 620, one or more calibration values may be determined from a lookup table as a function of the output signal. For example, the frequency of the tone from an audiometer may be determined and appropriate calibration values determined therefrom. At step 630, one or more characteristics of the output signal may then be varied as a function of the one or more calibration values to thereby control the electroactive bone conductive transducer. For example, the tone from the audiometer may be attenuated or amplified as a function of the calibration values and provided to a bone conduction transducer. An exemplary electoactive bone conduction transducer may be, but is not limited to, a piezoelectric bone conduction transducer and an electrostrictive bone conduction transducer.

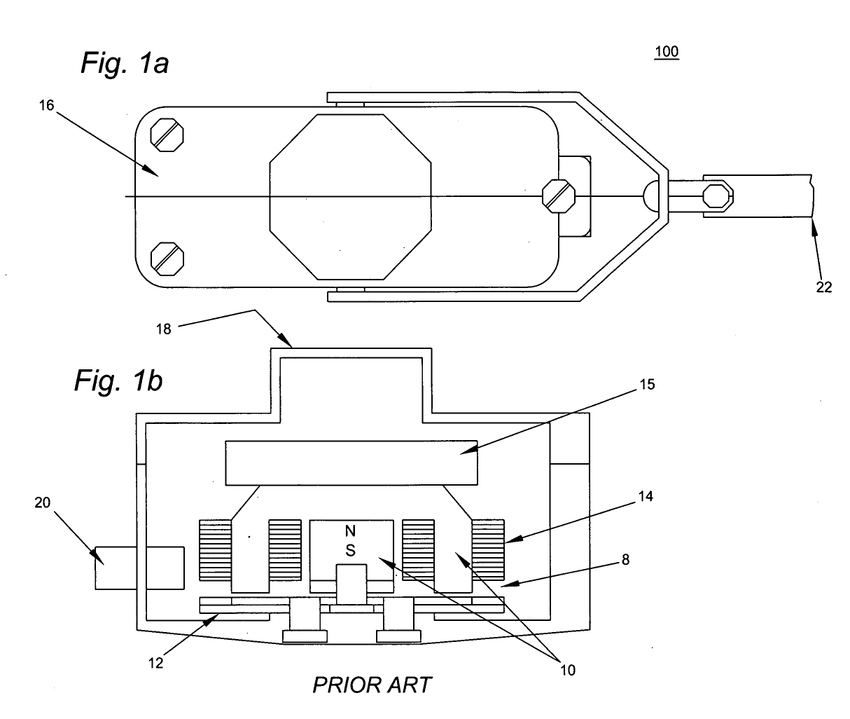

As shown by the various configurations and embodiments illustrated in FIGS. 1-6, a method and system for calibrating an audiometer signal have been described.

While preferred embodiments of the present subject matter have been described, it is to be understood that the embodiments described are illustrative only and that the scope of the invention is to be defined solely by the appended claims when accorded a full range of equivalence, many variations and modifications naturally occurring to those of skill in the art from a perusal hereof.

We claim:

1. In a method for providing a calibrated signal to a bone conduction transducer including detecting an output signal from an audiometer by determining a frequency of the output signal, the improvement comprising determining a calibration value from a lookup table as a function of the frequency and varying an amplitude of the output signal as a function of the calibration value to thereby provide the calibrated signal.

2. The method of claim 1, wherein the bone conduction transducer is selected from the group consisting of: a piezoelectric bone conduction transducer, an electrostrictive bone conduction transducer, and an electroactive bone conduction transducer.

3. The method of claim 1, wherein the determined frequency is determined as a function of a zero-crossing voltage condition of the output signal.

4. The method of claim 1, wherein the frequency is approximately in the range of 100 Hz to 8000 Hz.

5. A method for controlling an electroactive bone conduction transducer, comprising the steps of:
detecting an output signal from an audiometer calibrated at one or more frequencies for use with an electromagnetic transducer;
determining one or more calibration values from a lookup table as a function of the output signal; and
varying an amplitude of the output signal as a function of the one or more calibration values to thereby control the electroactive bone conductive transducer.

6. The method of claim 5, wherein the electoactive bone conduction transducer is selected from the group consisting of: a piezoelectric bone conduction transducer and an electrostrictive bone conduction transducer.

7. The method of claim 5, wherein the one or more frequencies are approximately in the range of 100 Hz to 8000 Hz.

8. A method for controlling a bone conduction transducer, comprising the steps of:
receiving an output signal from an audiometer;
generating a first signal as a function of a voltage condition of the output signal;
determining a first value of the first signal;
determining a second value as a function of the first value;
varying one or more characteristics of the output signal as a function of the second value to output a calibrated output signal; and
providing the calibrated output signal to a bone conduction transducer.

9. The method of claim 8, wherein the voltage condition is a zero-crossing voltage condition.

10. The method of claim 8, wherein the first signal is an edge signal.

11. The method of claim 8, wherein the first value is a frequency value.

12. The method of claim 11, wherein the frequency is approximately in the range of 100 Hz to 8000 Hz.

13. The method of claim 8, wherein the second value is a calibration value.

14. The method of claim 8, wherein determining a second value further comprises extracting the second value from a lookup table as a function of the first value.

15. The method of claim 8, wherein the one or more characteristics is selected from the group consisting of: attenuation and amplitude.

16. The method of claim 8, further comprising the steps of:
isolating the output signal; and
amplifying the output signal.

17. The method of claim 8, wherein the second value includes an attenuation parameter and an amplification parameter.

18. The method of claim 8, further comprising the steps of:
isolating the calibrated output signal; and
amplifying the calibrated output signal.

19. The method of claim 8, wherein the bone conduction transducer is selected from the group consisting of: a piezoelectric bone conduction transducer, an electrostrictive bone conduction transducer, and an electroactive bone conduction transducer.

20. A method for translating an audiometer signal, comprising the steps of:
detecting a voltage condition of an output signal from an audiometer;
outputting a first signal as a function of the voltage condition;
determining a first value of the first signal;
determining a second value as a function of the first value; and
varying one or more characteristics of the output signal as a function of the second value.

21. The method of claim 20, further comprising the step of:
driving a bone conduction transducer as a function of the output signal.

22. The method of claim 21, wherein the bone conduction transducer is selected from the group consisting of: a piezoelectric bone conduction transducer, an electrostrictive bone conduction transducer, and an electroactive bone conduction transducer.

23. The method of claim 20, wherein the voltage condition is a zero-crossing voltage condition.

24. The method of claim 20, wherein the first signal is an edge signal.

25. The method of claim 20, wherein the first value is a frequency value.

26. The method of claim 25, wherein the frequency is approximately in the range of 100 Hz to 8000 Hz.

27. The method of claim 20, wherein the second value is a calibration value.

28. The method of claim 20, wherein determining a second value further comprises extracting the second value from a lookup table as a function of the first value.

29. The method of claim 20, wherein the one or more characteristics is selected from the group consisting of: attenuation and amplitude.

30. The method of claim 20, further comprising the steps of:
isolating the output signal; and
amplifying the output signal.

31. The method of claim 20, wherein the second value includes an attenuation parameter and an amplification parameter.

32. A system for providing a calibrated signal to a bone conduction transducer comprising:
a voltage detector configured to detect a voltage condition of an output signal from an audiometer and to provide an edge signal;
circuitry for determining a calibration value as a function of the edge signal, the circuitry including a lookup table adaptable to provide the calibration value as a function of a frequency of the output signal; and
circuitry for adjusting one or more characteristics of the output signal as a function of the calibration value,
wherein the adjusted signal is provided to a bone conduction transducer.

33. The system of claim 32, wherein the one or more characteristics is selected from the group consisting of: attenuation characteristic and amplification characteristic.

34. The system of claim 32, wherein the circuitry for adjusting the one or more characteristics is selected from the group consisting of: variable attenuator and variable amplifier.

35. The system of claim 32, wherein the voltage condition is a zero-crossing voltage condition.

36. The system of claim 32, wherein the frequency is approximately in the range of 100 Hz to 8000 Hz.

37. The system of claim 32, wherein the calibration value includes an attenuation parameter and an amplification parameter.

38. The system of claim 32, further comprising:
a signal isolator configured to condition the output signal; and
an amplifier configured to amplify the conditioned signal.

39. The system of claim 32, further comprising:
a signal isolator configured to condition the adjusted signal; and
a voltage transformer configured to increase a voltage of the conditioned adjusted signal.

40. The system of claim 32, wherein the bone conduction transducer is selected from the group consisting of: a piezoelectric bone conduction transducer, an electrostrictive bone conduction transducer, and an electroactive bone conduction transducer.

41. A method comprising:
detecting a tone outputted from an audiometer;
determining the frequency of the tone;
determining a calibration value as a function of the frequency of the tone;
attenuating or amplifying the tone as a function of the calibration value; and
providing the attenuated or amplified tone to a bone conduction transducer.
